(19) United States
(12) Patent Application Publication
(10) Pub. No.: US 2013/0105373 A1
(43) Pub. Date: May 2, 2013

(54) Systems and Methods for User-Installable Chlorinators

(71) Applicants: Patrick Chen, North Kingstown, RI (US); Douglas Sawyer, Seekon, MA (US); Alan Levin, Bermuda Run, NC (US)

(72) Inventors: Patrick Chen, North Kingstown, RI (US); Douglas Sawyer, Seekon, MA (US); Alan Levin, Bermuda Run, NC (US)

(21) Appl. No.: 13/562,043

(22) Filed: Jul. 30, 2012

Related U.S. Application Data
(60) Provisional application No. 61/513,348, filed on Jul. 29, 2011.

(51) Int. Cl. E04H 4/12; F16L 55/07

(52) U.S. Cl. CPC E04H 4/1281; F16L 55/07
USPC 210/94; 210/167.11; 137/315.11; 137/15.17

(57) ABSTRACT

The present disclosure relates to a do-it-yourself kit for the installation of a pool or spa device, such as a chlorinator. A first nut associated with a first port, compression ring, collar, and face sealing gasket may be placed over a first pipe segment, and a second nut associated with a second port, compression ring, collar, and face sealing gasket may be placed over a second pipe segment. The chlorinator body can be placed between the two pipe segments such that first and second ports of the device are substantially coaxial with the first and second pipe segments, respectively. The first and second nut can be threadably secured to the first and second port, respectively, of the chlorinator. Also provided is a cutting template cutting template that may be placed over a pipe of a pool or spa plumbing system, and a saw for cutting the pipe.

### RELATED APPLICATIONS

This application claims the benefit of U.S. Provisional Application Ser. No. 61/513,348 filed Jul. 29, 2011, the disclosure of which is expressly incorporated herein by reference in its entirety.

### BACKGROUND

1. Technical Field

The present disclosure relates to a user-installable chlorinator, and more particularly, relates to a user-installable chlorinator that allows a user to safely and securely install the chlorinator without the need for professional assistance.

2. Related Art

In the pool and spa field, it is important that water be adequately sanitized to prevent the growth of microorganisms, algae, etc. Adequate sanitization is important not only to protect the health and safety of bathers, but to also ensure proper water clarity in a pool or spa. A number of sanitization techniques have been implemented to sanitize pool/spa water, such as chemical additives (e.g., chlorine, bromine, etc.), introduction of ozone into pool/spa water, ultraviolet sanitization, etc.

Electrolytic cells (or, so-called “salt chlorinators”) represent one way of sanitizing a pool or spa. In this arrangement, an amount of salt (sodium chloride) is periodically added to pool or spa water (e.g., a few times per year), an electric charge is imparted on the electrolytic cell, and pool or spa water is pumped through the cell. Through electrolysis, the salt in the water is converted to free chlorine, which is subsequently pumped into the pool or spa to sanitize water. One advantage to this approach is a reduction in the amount of chemicals that need to periodically be added to pool or spa water, in contrast to conventional chemical chlorination techniques which require frequent addition of dry or liquid chemicals to the pool/spa (e.g., by way of powder, tablets, etc.) in order to sanitize same.

The currently accepted method for attaching devices, e.g., salt chlorinators, to existing pool or spa plumbing involves the use of PVC solvent cement. This method is effective, but requires the use of environmentally and physically harmful, noxious, and flammable chemicals. Many pool or spa owners are reluctant to use these chemicals due to the dangers they may encounter. Therefore, many potential self-installers avoid installing such equipment and rely on professional installation, which is significantly more expensive. Further, the methods that employ chemical solvents or adhesives require that the size of the piping matches the port sizes of the device being installed. This means that different sized pipes can not be attached to the same device. Even further, using solvents or adhesives to bond the piping with the device requires that the plumbing pipes overlap into the vessel arms.

The present disclosure overcomes one or more of the drawbacks and/or disadvantages of the prior art discussed above.

### SUMMARY

The present disclosure relates to a do-it-yourself kit for the installation of a pool or spa device, such as a chlorinator. A cutting template, a PVC saw, a compression ring, a collar and a face sealing gasket are provided. The cutting template may include one or more cutting guides and associated cutting slots. The cutting template may be placed over a pipe of a pool or spa plumbing system and the PVC saw used to cut the pipe. The PVC saw may be guided by and travel through the one or more cutting guides and one or more cutting slots. After a section of the pipe is removed, a first nut associated with the first port, a compression ring, a collar and a face sealing gasket may be placed over the first pipe segment, and a second nut associated with the second port, a compression ring, a collar and a face sealing gasket may be placed over the second pipe segment. A device can be placed between the two pipe segments such that a first port of the device is substantially coaxial with the first pipe segment, and a second port of the device is substantially coaxial with the second pipe segment. The first nut can be threadably secured to the first port and tightened such that the compression ring, the collar and the face sealing gasket are compressed with the compression ring compressing against the first pipe segment, and in some instances, causing the first pipe segment to slightly deform. The second nut can be threadably secured to the second port and tightened such that the compression ring, the collar and the face sealing gasket are compressed with the compression ring compressing against the second pipe segment, and in some instances, causing the second pipe segment to slightly deform.

In one embodiment, the present invention provides a user-installable chlorinator comprising a chlorinator body for removably receiving a chlorinator cartridge, said chlorinator body including first and second flow ports for allowing water flow through said chlorinator body and an area for receiving a chlorinator cartridge; first and second compression fittings for attaching the first and second flow ports of said chlorinator to first and second pipe segments of a pool or a spa plumbing system; and a screw cap threadably engageable with a cartridge port of said chlorinator body for securing the chlorinator cartridge within said chlorinator body.

In another embodiment, the present invention provides a kit for allowing a user to install a chlorinator, comprising a chlorinator body for removably receiving a chlorinator cartridge; a cutting template positionable about a pipe of a pool or a spa plumbing system; a saw for cutting the pipe at locations indicated by the cutting template; and a plurality of compression fittings for attaching first and second segments of the pipe, after cutting of the pipe using the saw, to first and second flow ports of the chlorinator.

In another embodiment, the present invention provides a method for installing a chlorinator, comprising the steps of cutting and removing a portion of a pipe associated with a plumbing system for a pool or a spa to form a first and second pipe segments; placing a first nut, a first compression ring, a first collar, and a first face sealing gasket over the first pipe segment; placing a second nut, a second compression ring, a second collar, and a second face sealing gasket over the second pipe segment; placing a chlorinator between the first and second pipe segments so that the first pipe segment is adjacent to and substantially coaxial with a first flow port of the chlorinator, and the second pipe segment is adjacent to and substantially coaxial with a second flow port of the chlorinator; securing the first pipe segment to the chlorinator by threadably engaging the first nut with the first flow port; and securing the second pipe segment to the chlorinator by threadably engaging the second nut with the second flow port.

### BRIEF DESCRIPTION OF THE DRAWINGS

The foregoing features of the invention will be apparent from the following Detailed Description, taken in connection with the accompanying drawings, in which:

FIG. 1 is a perspective view of a chlorinator and controller of the present invention;

FIG. 2 is a first exploded view of the chlorinator;

FIG. 3 is a second exploded view of the chlorinator illustrating first and second glamour plates;

FIG. 4 is a partial sectional view of the chlorinator, piping, and compression fittings of the present disclosure, showing details of the sealing engagement provided by the compression fittings;

FIG. 5 is a sectional view of the sealing engagement of FIG. 4 showing an enlarged view of area 5 of FIG. 4;

FIG. 6 is a perspective view of a chlorinator cartridge;

FIG. 7 is a partial perspective view of a cartridge lid;

FIG. 8 is a front view of a controller; and

FIG. 9 is an isometric view of the pipe cutting kit of the present invention.

### DETAILED DESCRIPTION

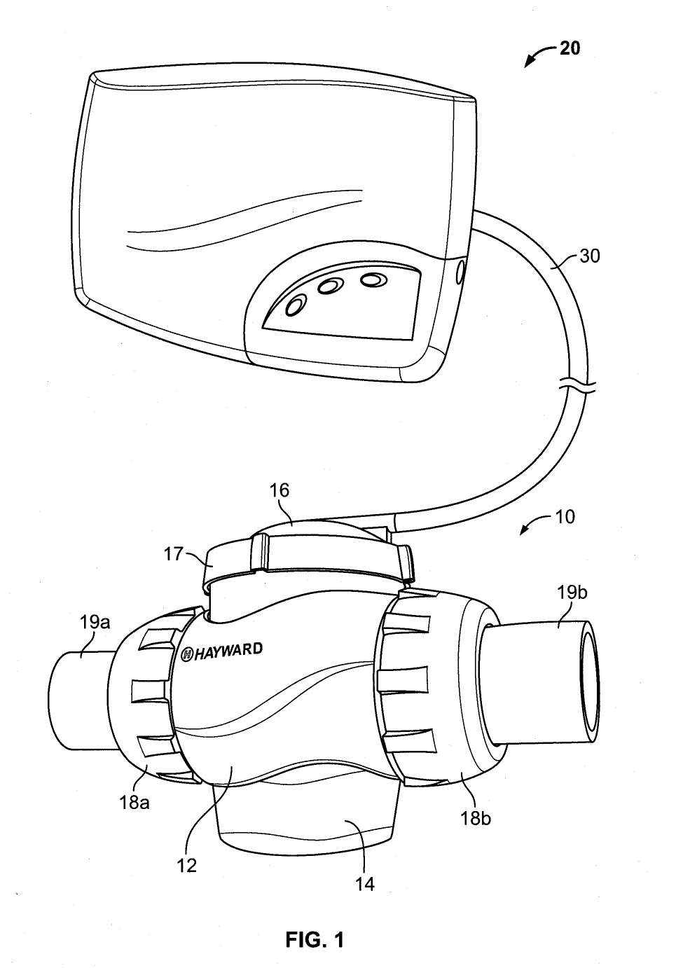

The present disclosure relates to systems and methods for user-installable chlorinators, as discussed in detail below in connection with FIGS. 1-9. As used herein, the terms “cell” and “chlorinator” are used interchangeably.

In FIG. 1, a perspective view of a chlorinator 10 and a controller 20 of the present invention is shown. The system includes the chlorinator 10 and the controller 20, which are electrically interconnected by a cable 30. The cable 30 allows for two-way communication between the controller 20 and the chlorinator 10. The two-way communication allows the controller 20 to provide the chlorinator 10 with instructions, and allows the chlorinator 10 to provide the controller 20 with details regarding status, operational parameters (e.g., temperature, flow detection, pH levels, etc.), and history, among other things.

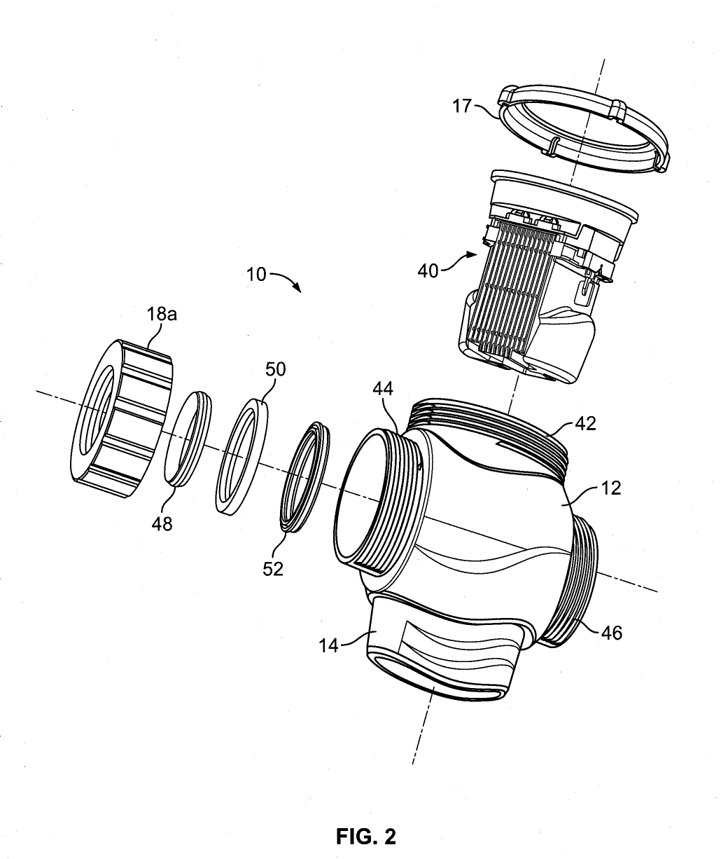

The chlorinator 10 includes a casing 12, a transparent or translucent body 14, a screw cap 17, a first nut 18a, and a second nut 18b. The nuts 18a, 18b permit connection of a first pipe segment 19a and a second pipe segment 19b to the chlorinator 10. The body 14 houses a chlorinator cartridge (or cell) 40 (see FIG. 2), discussed in greater detail below. The cable 30 extends from the controller 20 and connects to a cartridge lid 16 that couples to the chlorinator cartridge 40. The cable 30 extends from the exterior of the cartridge lid 16 to the interior, thus providing electrical communication between the controller 20 and the chlorinator cartridge 40. The cable 30 is secured to a cable port with a water-tight seal. The cartridge lid 16 is sealingly secured to the chlorinator cartridge 40. Secured to the chlorinator 10 are the first pipe segment 19a and the second pipe segment 19b. The pipe segments 19a, 19b are secured to the chlorinator 10 by a first nut 18a and a second nut 19b, respectively. Details of this attachment are described in greater detail below. It is noted that communication between the chlorinator 10 and the controller 20 could also be provided by way of a wireless connection in place of the cable 30.

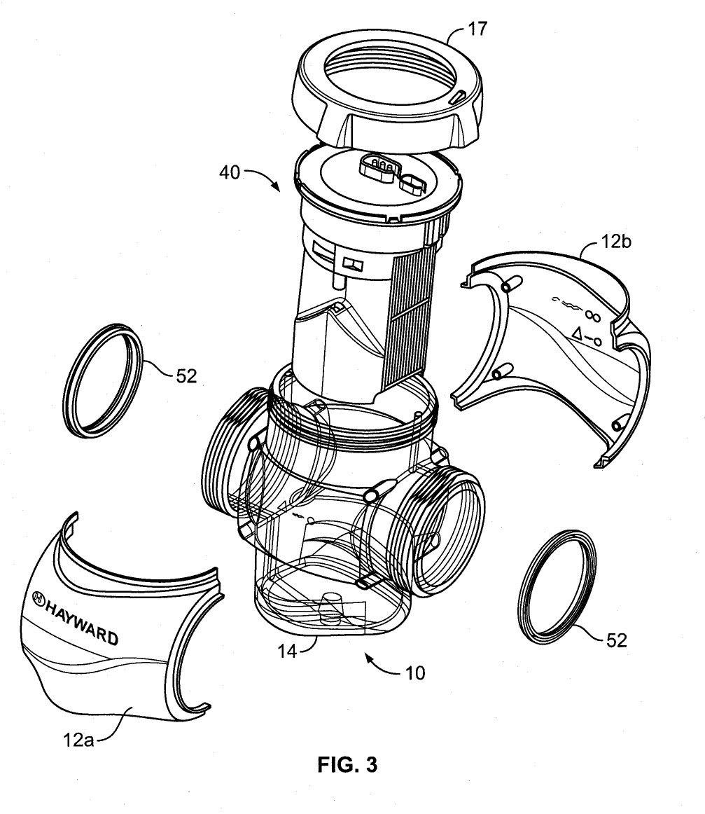

FIGS. 2 and 3 show an exploded view of the chlorinator 10 including the chlorinator cartridge 40. As illustrated in FIG. 2, the body 14 includes a cartridge port 42, first flow port 44 and second flow port 46. As shown in FIG. 3, the chlorinator 10 may include a first glamour plate 12a and a second glamour plate 12b which form the casing 12. The cartridge port 42 provides an opening that allows the chlorinator cartridge 40 to be inserted into and placed within the body 14. The cartridge port 42 also includes external threading that mates with the internal threading of the screw cap 17, allowing the screw cap 17 to be secured to the cartridge port 42. The first flow port 44 and the second flow port 46 also include external threading that allows the first nut 18a and the second nut 18b to be threadably attached to the respective flow ports 44, 46. Positioned between each nut 18a, 18b and the respective flow ports 44, 46 are compression rings 48, collars 50, and face sealing gaskets 52. Together with the nuts 18a, 18b, these components comprise compression fittings which sealingly secure the pipe segments 19a, 19b to the chlorinator 10.

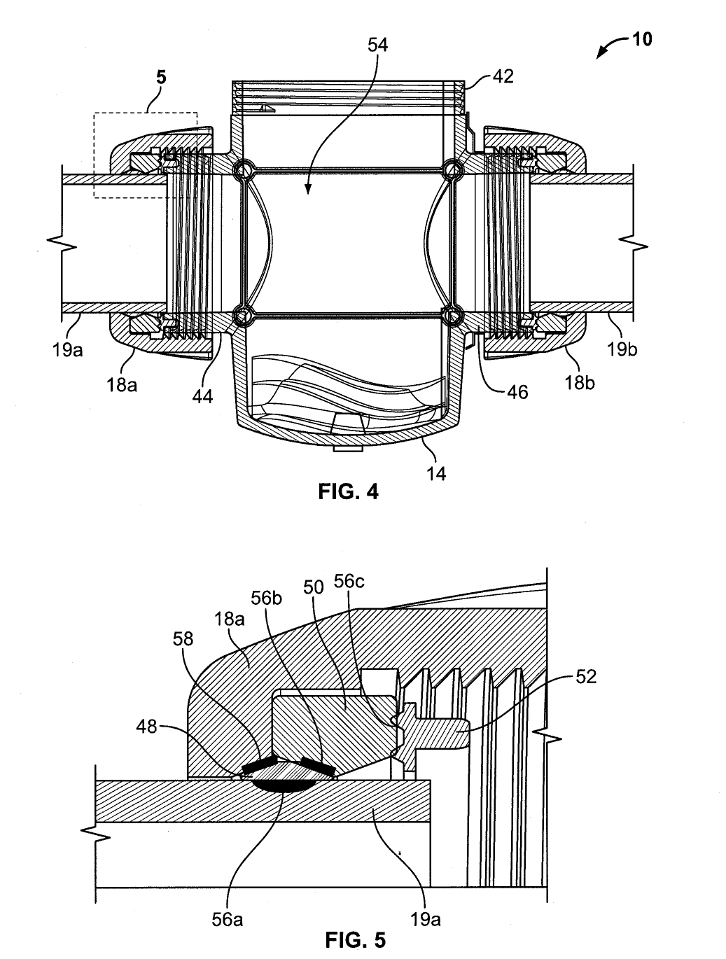

FIG. 4 is a partial sectional view of the chlorinator 10 sealingly engaged with the first pipe segment 19a and the second pipe segment 19b. The body 14 of the chlorinator 10 defines a cartridge housing area 54 that receives the chlorinator cartridge 40. FIG. 5 shows a more detailed view of the compression fittings as well as highlighting the sealing areas that are generated. Importantly, the sealing relationship between the first flow port 44, first pipe segment 19a, first nut 18a, compression ring 48, collar 50, and face sealing gasket 52, is the same for the second flow port 44, second pipe segment 19b, second nut 18b, compression ring 48, collar 50, and face sealing gasket 52. That is, there is an identical sealing assembly at both flow ports 44, 46. The components are arranged such that the face sealing gasket 52 engages, and is compressed between, a front annular face of the first flow port 44 and the collar 50, and the compression ring 48 is compressed against the first pipe segment 19a. The compression ring 48 may have first and second slanted surfaces which engage, respectively, a slanted surface of the first nut 18a and a slanted surface of the collar 50. Importantly, the first pipe segment 19a is inserted through the compression ring 48 so that the compression ring 48 surrounds the first pipe segment 19a.

During installation, threadably tightening the first nut 18a on to the first flow port 44 causes the first nut 18a to drive the collar 50, the compression ring 48, and the face sealing gasket 52 toward the first flow port 44. When fully tightened, the face sealing gasket 52 is compressed between the front annular face of the first flow port 44 and the collar 50. Further, the compression ring 48 is compressed between the first nut 18a and the collar 50, and deforms to form a seal against the outer surface of the first pipe segment 19a. Additionally, the compression ring 48 slightly deforms the first pipe segment 19a, thereby preventing it from backing off under pressure-induced thrust loading. As a result, the first pipe segment 19a does not require secondary restraint under proper pool pressures. When the first nut 18a is fully tightened to the first flow port 44, and the compression fitting is fully compressed, three primary sealing areas 56a, 56b, 56c result. The first primary sealing area 56a is created between the compression ring 48 and the first pipe segment 19a. The second primary sealing area 56b is formed between the collar 50 and the compression ring 48. The third primary sealing area 56c is formed between the collar 50 and the face sealing gasket 52. The primary sealing areas 56a, 56b, 56c fully encircle the first pipe segment 19a so that a complete water-tight seal is formed. As mentioned previously, a compression ring 48, a collar 50 and a face sealing gasket 52 are also engaged with the second flow port 46, second nut 18b and second pipe segment 19b, so as to seal the second flow port 46 and the second pipe segment 19b. Further, this arrangement may be provided for any additional inlets or outlets that may be present on alternative embodiments of the chlorinator 10, or any other device that may be installed. Engaging the first pipe segment 19a and the second pipe segment 19b with the chlorinator 10 creates a fluid tight system where water can flow from the first pipe segment 19a into the chlorinator 10 and out the second pipe segment 19b to be recirculated into a pool, spa, or other water facility into which the chlorinator 10 may be incorporated.

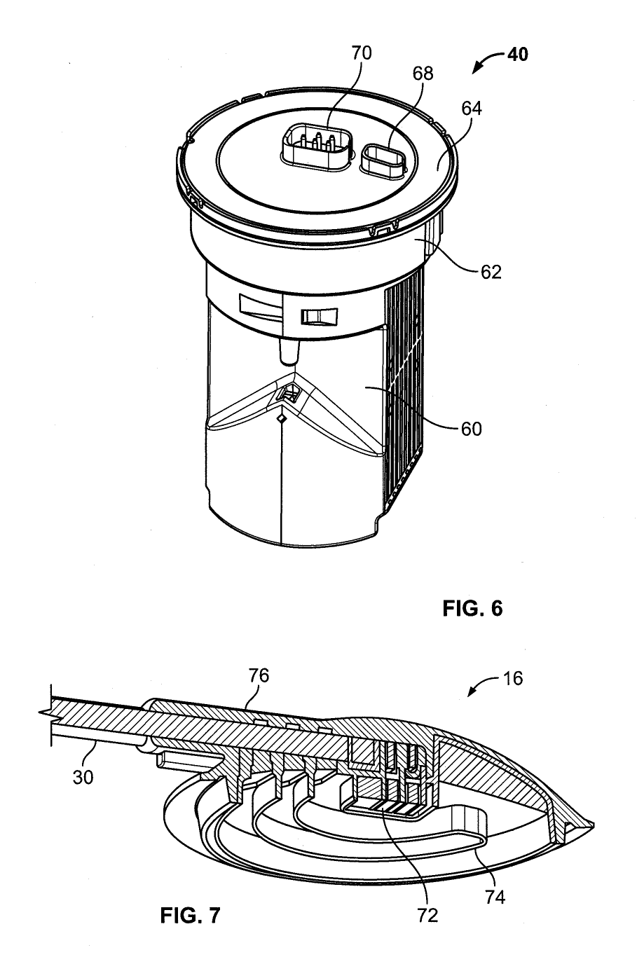

As mentioned previously, the body 14 of the chlorinator 10 defines a cartridge housing area 54 that receives and houses the chlorinator cartridge 40. FIG. 6 is a perspective view of the chlorinator cartridge 40. The chlorinator cartridge 40 includes a cartridge body 60, cartridge cap 62, cover 64 and o-ring 66. The cover 64 includes a locking key 68 and an electrical connector 70 having a plurality of connector pins 71. The plurality of connector pins 71 extend through the cover 64 and are in electrical connection with the electrical components of the chlorinator cartridge 40. When the chlorinator cartridge 40 is inserted into the chlorinator 10, and housed in the cartridge housing area 54, the o-ring 66 engages a front annular face of the cartridge port 42 such that the o-ring 66 is compressed between the cartridge port 42 and a lip of the cartridge cap 62. The o-ring 66 may alternatively be a flat gasket or other sealing agent, or replaced by any other known sealing methodology.

FIG. 7 is a partial perspective view of the cartridge lid 16. The cartridge lid 16 includes a connector terminal 72 and a locking protrusion 74, both disposed on the underside of the cartridge lid 16. The cartridge lid 16 also includes a cable port 76 that protrudes from the top of the cartridge lid 16. The cable port 76 provides an entrance for the cable 30 so it is in electrical communication with the connector terminal 76, and creates a water-tight seal with the cable 30, restricting water from coming in contact with the connector terminal 76. The cartridge lid 16 is configured to be positioned adjacent the cover 64 so that the locking key 68 engages the locking protrusion 74, restricting rotational movement, and the connector pins 71 engage the connector terminal 72. When the cartridge lid 16 is connected with the cover 64, i.e., when the connector pins 71 are engaged with the connector terminal 72, the cable 30 is in electrical communication with the electrical components of the chlorinator cartridge 40.

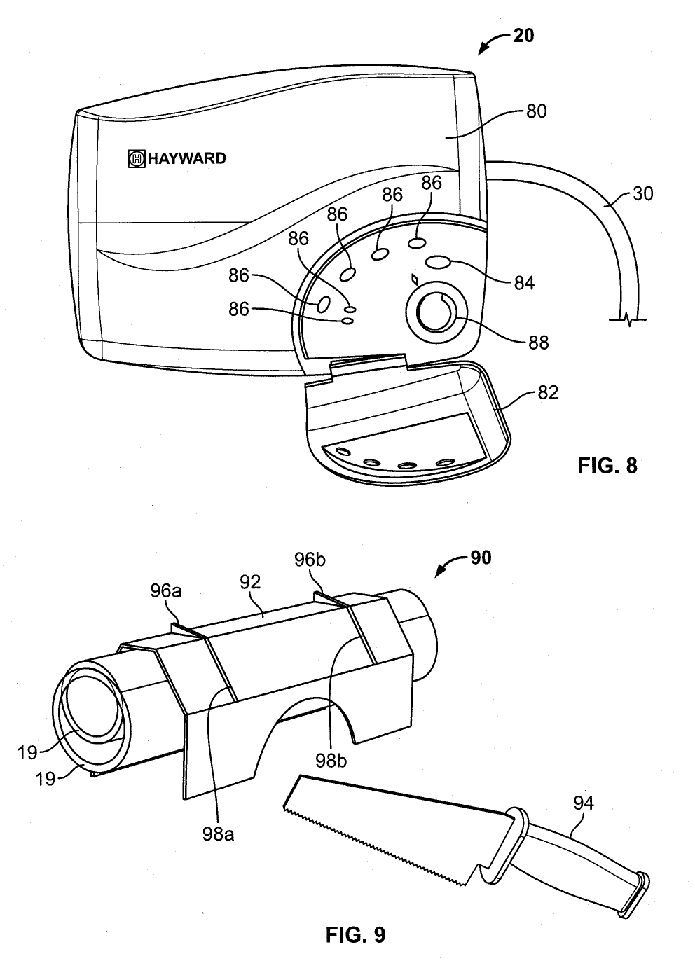

FIG. 8 is a front view of a controller 20 of the present invention. The cable 30 is connected to the cartridge lid 16 and runs from the controller 20 to the connector lid 16, placing the two in electrical communication. The controller 20 may include a housing 80, controller cover 82, a “super chlorinate” button 84, a plurality of status lights 86, and a control knob 88. The controller 20 functions to adjust the operating parameters of the chlorinator cartridge 40 and may receive data from the chlorinator cartridge 40 regarding operational information and parameters. This information may be utilized by the controller 20 to activate any one of the plurality of status lights 86 to inform a user of various operating conditions. The plurality of status lights 86 may alternatively be a single or a plurality of LCD screens or other display technology that is known. These conditions may, for example, be any one of a standby mode, need for increase or decrease in chlorinator output, need for chlorinator replacement, error condition, or any other condition that may be feasible. The control knob 88 may be rotated by a user to adjust the daily chlorine output to a desired level. Further, the control cover 82 may be hingedly attached to the controller housing 80 such that it can be closed or opened. When in a closed position, the control cover 82 covers the control knob 88, but may include a plurality of holes which align with the plurality of status lights 86. This allows a user to view the status of the system without having to open the control cover 82. When a user desires to adjust the chlorine output, he or she may simply flip the control cover 82 down and rotate the control knob 88. The controller 20 may be mountable so that it can be mounted on a wall or a post, depending on user preference.

The present invention provides a do-it-yourself installation kit so that a user can self-install the chlorinator 10 into a pre-existing pool or spa plumbing system. FIG. 9 is a perspective view of a pipe cutting kit 90 of the present invention. The pipe cutting kit 90 includes a cutting template 92 and a PVC saw 94. The cutting template 92 includes a first cutting guide 96a and a second cutting guide 96b which are respectively adjacent to a first cutting slot 98a and a second cutting slot 98b. The first and second cutting guides 96a, 96b are each a bifurcated protrusion extending from the cutting template 92 that allow the PVC saw 94 to be inserted between the bifurcation. The PVC saw 94 may be inserted into the cutting guides 96a, 96b and moved downward to enter the first and second cutting slots 98a, 98b. The cutting template 92 generally has the geometry of an open polygon. In the illustrated embodiment of FIG. 9, the cutting template 92 has five sides (i.e., two vertical walls, two slanted walls, and a horizontal top wall connecting the two slanted walls) with an open bottom. The purpose of this geometry is to allow a user to place the cutting template 90 over a pipe 19 with the pipe 19 contacting the inside of the top wall and the slanted walls of the cutting template 90. By having the slanted walls, the cutting template 90 can accommodate pipes 19, 19′ of various sizes. For instance, a first pipe 19 having a first diameter and a second pipe 19′ having a smaller diameter may both be accommodated by the same template 92, as illustrated in FIG. 9.

Turning to the self-installation aspect, the self-installation process will now be described. A user first places the cutting template 92 over an appropriate portion of a PVC pipe 19 associated with a pool or spa plumbing system. A user may then insert the PVC saw 94 into the first cutting guide 96a and begin to saw the pipe 19. As the PVC saw 94 cuts across the diameter of the pipe 19 it travels further along, and is guided by, the first cutting slot 98a. The user continues to saw the pipe 19 until it is fully cut through. This process is then repeated for the second cutting guide 96a and the second cutting slot 98b. Importantly, the cutting template 92 is retained in the same position, i.e., the first cutting slot 98a remains over the first cut, while the second cut is made so that an exact amount of pipe 19 is removed. When both cuts are made, the cut portion of the pipe 19 may be discarded, and the user is now left with a first pipe segment 19a and a second pipe segment 19b, as shown in FIGS. 1 and 4.

The user then places the first nut 18a, the compression ring 48, the collar 50, and the face sealing gasket 52 over the first pipe segment 19a, in that order, and places the second nut 18b, a second compression ring 48, a second collar 50, and a second face sealing gasket 52 over the second pipe segment 19b, in that order. The chlorinator 10 is then placed between the first pipe segment 19a and the second pipe segment 19b, such that the first pipe segment 19a is adjacent to and substantially coaxial with the first flow port 44, and the second pipe segment 19b is adjacent to and substantially coaxial with the second flow port 46. The first nut 18a is then threadably engaged with the first flow port 44 and the second nut is threadably engaged with the second flow port 46. The user then tightens the first nut 18a, which drives the first nut 18a, the compression ring 48, the collar 50, and the face sealing gasket 52 toward the annular face of the first flow port 44. Continued tightening of the first nut 18a causes the nut to drive the collar 50 and compress the face sealing gasket 52 against the annular face of the first flow port 44. Further, the continued tightening causes the compression ring 48 to be compressed between the first nut 18a, the collar 50, and the outer surface of the first pipe segment 19a. When the first nut 18a is fully tightened, the first pipe segment 19a is secured with the chlorinator 10. This procedure is then repeated for the second nut 18b, the second flow port 46, and the second pipe segment 19b, such that when the second nut 18b is fully tightened to the second flow port 46 the second pipe segment 19b is fully secured with the chlorinator 10. When the first pipe segment 19a and the second pipe segment 19b are fully secured to the chlorinator 10 the pipe segments 19a, 19b are in fluidic communication.

Once the first pipe segment 19a and the second pipe segment 19b are fully secured to the chlorinator 10, the chlorinator cartridge 40 can be inserted into the chlorinator 10 where it is housed in the cartridge housing area 54. When inserted, the o-ring 66 engages the front annular wall of the cartridge port 42 and is compressed between a lip of the cartridge cap 62 and the front annular wall of the cartridge port 42. The screw cap 17 is then placed over the cartridge cap 62 and threadably secured to the cartridge port 42, securing the cartridge 40 within the chlorinator 10. The cartridge lid 16 is then placed adjacent the screw cap 17 and the cartridge cap cover 64 and attached thereto such that the connector pins 71 extending through the cartridge cap cover 64 engage the connector terminal 72 of the cartridge lid 16 and the locking key 68 is secured within the locking protrusion 74. The cable 30 can then be attached to the controller 20 and the system is ready for operation.

The compression fittings, i.e., the nuts 18a, 18b, the compression ring 48, the collar 50, and the face sealing gasket 52, form a system that does not require any chemicals to secure the pipe segments 19a, 19b to the chlorinator 10. This makes the “do-it-yourself” aspect of the present invention much more user friendly, especially for those users who do not wish to use environmentally and physically harmful, noxious, or flammable chemicals. Further, this system enables different sized pipes to attach to the same vessel using different component sets. Even further, this system does not require the pool or spa plumbing pipes to overlap into the vessel ports.

Importantly, while reference is made herein to a chlorinator, it is noted that the installation components and techniques described herein could be utilized to install other types of equipment in a pool/spa environment. For example, the device attached to the pool or spa plumbing may be an erosion feeder, UV sanitizer, ozone sanitizer, or any other device.

Although the foregoing disclosure was discussed in connection with pools and spas, it is to be understood that the systems and methods disclosed herein could be utilized in connection with any body of water where sanitization is necessary, e.g., fountains, ponds, water features, etc.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention.

1. A user-installable chlorinator, comprising:
a chlorinator body for removably receiving a chlorinator cartridge, said chlorinator body including first and second flow ports for allowing water flow through said chlorinator body, and an area for receiving a chlorinator cartridge;
first and second compression fittings for attaching the first and second flow ports of said chlorinator to first and second pipe segments of a pool or a spa plumbing system; and
a screw cap threadably engageable with a cartridge port of said chlorinator body for securing the chlorinator cartridge within said chlorinator body.

2. The chlorinator of claim 1, wherein the first and second compression fittings each include a nut, a compression ring, a collar, and a face sealing gasket.

3. The chlorinator of claim 2, wherein the nut biases the compression ring against a respective pipe segment and the face sealing gasket against the chlorinator body.

4. The chlorinator of claim 1, further comprising a connector lid in electrical communication with a controller via a cable, and removably connectable to the cartridge.

5. The chlorinator of claim 4, wherein a cover of the cartridge comprises a locking key engageable with corresponding locking protrusions of the lid.

6. The chlorinator of claim 1, further comprising a controller in electrical communication with the chlorinator cartridge for controlling the chlorinator.

7. The chlorinator of claim 1, wherein at least a portion of the body of the chlorinator is transparent.

8. A kit for allowing a user to install a chlorinator, comprising:
a chlorinator body for removably receiving a chlorinator cartridge;
a cutting template positionable about a pipe of a pool or a spa plumbing system;
a saw for cutting the pipe at locations indicated by the cutting template; and
a plurality of compression fittings for attaching first and second segments of the pipe, after cutting of the pipe using the saw, to first and second flow ports of the chlorinator.

9. The kit of claim 8, wherein the plurality of compression fittings include a plurality of nuts, a plurality of compression rings, a plurality of collars, and a plurality of face sealing gaskets.

10. The kit of claim 8, wherein the cutting template comprises first and second cutting slots.

11. The kit of claim 8, further comprising a connector lid in electrical communication with a controller via a cable, and removably connectable with the cartridge.

12. A method for installing a chlorinator, comprising the steps of:
cutting and removing a portion of a pipe associated with a plumbing system for a pool or a spa to form a first and second pipe segments;
placing a first nut, a first compression ring, a first collar, and a first face sealing gasket over the first pipe segment;
placing a second nut, a second compression ring, a second collar, and a second face sealing gasket over the second pipe segment;
placing a chlorinator between the first and second pipe segments so that the first pipe segment is adjacent to and substantially coaxial with a first flow port of the chlorinator, and the second pipe segment is adjacent to and substantially coaxial with a second flow port of the chlorinator;
securing the first pipe segment to the chlorinator by threadably engaging the first nut with the first flow port; and
securing the second pipe segment to the chlorinator by threadably engaging the second nut with the second flow port.

13. The method of claim 12, wherein the step of securing the first pipe segment comprises driving the first nut, the first compression ring, the first collar, and the first sealing gasket toward the first flow port.

14. The method of claim 12, wherein the step of securing the second pipe segment comprises driving the second nut, the second compression ring, the second collar, and second sealing gasket toward the second flow port.

15. The method of claim 12, further comprising inserting a chlorinator cartridge into the chlorinator.

16. The method of claim 15, further comprising securing the cartridge within the chlorinator using a screw cap threadably engageable with the chlorinator.

17. The method of claim 12, further comprising connecting the chlorinator cartridge to a controller for controlling the chlorinator.

18. The method of claim 12, further comprising placing a cutting template over a portion of the pipe to indicate locations for cutting the pipe prior to cutting and removing the portion of the pipe.

19. The method of claim 18, further comprising cutting the pipe using a saw at the locations identified by the template.
